(19) United States
(12) Patent Application Publication
(10) Pub. No.: US 2010/0045817 A1
(43) Pub. Date: Feb. 25, 2010

(54) CAMERA CONTROL APPARATUS AND CAMERA CONTROL METHOD

(76) Inventor: Makoto SAIJO, Kanagawa (JP)

Correspondence Address: FROMMER LAWRENCE & HAUG, 745 FIFTH AVENUE- 10TH FL., NEW YORK, NY, 10151, US

(21) Appl. No.: 12/611,232

(22) Filed: Nov. 3, 2009

(30) Foreign Application Priority Data
Apr. 11, 2008 (JP) P2008-283628

(51) Int. Cl. H04N 5/228

(52) U.S. Cl. 348/222.1; 348/E05.031

(57) ABSTRACT

A camera control apparatus includes: a first operation section outputting a first operation signal in accordance with the displacement amount, the first operation signal instructing a camera to perform pan or tilt control; a second operation section outputting a second operation signal in accordance with the displacement amount, the second operation signal limiting the speed at which the camera is moved; a maximum value variable producer producing a maximum value variable that limits the speed within a predetermined range based on the second operation signal; a speed determination section determining the speed in accordance with the first operation signal so that the speed is smaller than or equal to the maximum value variable; and a control signal producer producing a control command for controlling the direction in which the camera is moved and the speed based on the determined speed at which the camera is moved.

### BACKGROUND OF THE INVENTION

1. Field of the Invention

The present invention relates to a camera control apparatus and a camera control method, for example, suitably applied to camera operation control.

2. Description of the Related Art

A video switcher has been known as an apparatus that relays live video images being captured by a camera and produces content based on the video images captured by the camera. More specifically, a video switcher is an apparatus that receives video signals from a plurality of channels, selects any of the video signals and outputs the selected video signal to a projector or any other destination to which video images are outputted, and exerts wiping and other effects on a video image when the video image is switched to another.

Using a video switcher also readily allows a video image outputted as a current on-air video image (PGM output video image) to be switched to a video image that will be outputted as the next on-air video image (NEXT output video image, which is also referred to as a preview output video image).

The video switcher can also display the PGM output video image and the NEXT output video image, before they are switched, in a multi-view display format on a screen of a display device or any other suitable component that is the destination to which the video images are outputted so that a user can check both the images simultaneously. In the multi-view display format, a screen is divided into a plurality of areas and video images produced from different video signals are displayed in the respective areas. The display format allows the user to look at a PGM output video image being outputted as an on-air video image and align or otherwise adjust a NEXT output video image that is next put on the air.

When a plurality of cameras are used to capture the live video images described above, a camera controller that controls the operation of each of the plurality of cameras is often used as well as a video switcher. A camera controller is an apparatus that remotely performs, for example, iris, focus, and zoom control in each of the cameras connected to the camera controller via cables or any other suitable component.

JP-A-10-150585 discloses a technology in which a camera control unit and a video switcher are used to control the operation of a video camcorder and perform video image processing at the same time.

### SUMMARY OF THE INVENTION

In a camera controller of related art, a joy stick is used to determine a vector (the direction and amount of displacement). “The direction and amount of displacement of the joy stick” mean the direction of displacement (angle) and the amount of displacement (travel) produced when the user inclines the lever of the joy stick and measured relative to an initial position (zero) of the joy stick, where the joy stick is brought into a stationary state when the user releases the lever. In related art, the amount of displacement of the joy stick correlates with the speeds at which pan, tilt, zoom, and other parameters of a camera under operation are controlled. Therefore, when the lever of the joy stick is unstable, the direction and amount of displacement of the joy stick produced by the unstableness directly affect the direction in which the camera is moved and the speed at which the camera is moved, causing the motion of the camera to be unstable.

The lever of the joy stick is unstable because the strength produced by the muscle in the arm of the user tries to balance with the force of a spring in the joy stick so that an intermediate displacement (the direction and amount of displacement of the joy stick when the user keeps the lever at fixed inclination) is maintained. However, since it is difficult to keep the lever stationary without any unstableness, the speed at which the camera is moved may not be constant, and the user may not be able to move the camera in a desired direction at a desired speed.

Further, when the joy stick is displaced to an intermediate position, the direction and amount of displacement of the joy stick vary. The variation results from undesired motion caused by the fluctuation in a speed parameter (a value that defines the speed at which the camera is moved) produced by the joy stick. As described above, when the joy stick is used to determine the direction and amount of displacement, the user benefits from its intuitive operation, whereas it is difficult to specify a fixed amount and direction of displacement because the joy stick is unstable when displaced to an intermediate position.

Moreover, when the joy stick is used to drive a camera in two (pan/tilt) directions, and the maximum movement speed is limited in one of the directions, the ratio of the movement speed in the pan direction to the movement speed in the tilt direction disadvantageously changes. In this case, the camera could be moved in a direction different from the direction of user's intention.

Thus, it is desirable to operate a camera in the direction and at the speed of user's intention.

According to an embodiment of the invention, a first operation signal that instructs a camera to perform pan or tilt control is outputted in accordance with the amount of displacement of a first operation section, and a second operation signal that limits the speed at which the camera is moved is outputted in accordance with the amount of displacement of a second operation section.

A maximum value variable that limits the speed at which the camera is moved within a predetermined range is then produced based on the second operation signal, and the speed at which the camera is moved is determined in accordance with the first operation signal so that the speed is smaller than or equal to the maximum value variable.

A control command for controlling the direction in which the camera is moved and the speed at which the camera is moved is produced based on the determined speed at which the camera is moved.

According to the apparatus described above, the speed at which the camera is moved can be adjusted to a value smaller than or equal to the maximum value variable, whereby the camera can be operated in the direction and at the speed of user's intention.

According to an embodiment of the invention, operating the second operation section allows the speed at which the camera is moved to be adjusted to a value smaller than or equal to the maximum value variable, whereby the camera can be operated in the direction and at the speed of user's intention. The first operation section is used to move the camera readily to a predetermined position at a predetermined speed.

### BRIEF DESCRIPTION OF THE DRAWINGS

FIG. 1 is a schematic diagram showing an exemplary configuration of a system in a first embodiment of the invention;

FIG. 2 is a descriptive diagram showing an exemplary configuration of an operation input unit in the first embodiment of the invention;

FIG. 3 is a perspective view showing an exemplary external configuration of a joy stick in the first embodiment of the invention;

FIG. 4 is a block diagram showing an exemplary internal configuration of a video signal processing apparatus in the first embodiment of the invention;

FIG. 5 is a block diagram showing an exemplary process of producing a control command in the first embodiment of the invention;

FIG. 6 is a block diagram showing an exemplary internal configuration of a control section in the first embodiment of the invention;

FIGS. 7A to 7C are block diagrams showing exemplary processes of determining a speed parameter in the first embodiment of the invention;

FIG. 8 is a block diagram showing an exemplary process of determining master and slave parameters in the first embodiment of the invention;

FIG. 9 is a flowchart showing an exemplary process of determining the master and slave parameters in the first embodiment of the invention;

FIG. 10 is a block diagram showing an exemplary process of producing a control command in a second embodiment of the invention; and

FIG. 11 is a block diagram showing an exemplary process of producing a control command in a third embodiment of the invention.

### DESCRIPTION OF THE PREFERRED EMBODIMENTS

The best mode for carrying out the invention (hereinafter referred to as embodiments) will be described below with reference to the accompanying drawings. The description will be made in the following order

1. First embodiment (control the speed at which a camera is moved: an exemplary process of determining the speed at which a camera is moved)

2. Second embodiment (control the speed at which a camera is moved: an exemplary process of carrying out an interrupt process based on a hold button signal)

3. Third embodiment (control the speed at which a camera is moved: an exemplary process of extracting low-frequency components from an operation signal outputted from a joy stick)

4. Variations

### 1. First Embodiment

[Control the speed at which a camera is moved: an exemplary process of determining the speed at which a camera is moved]

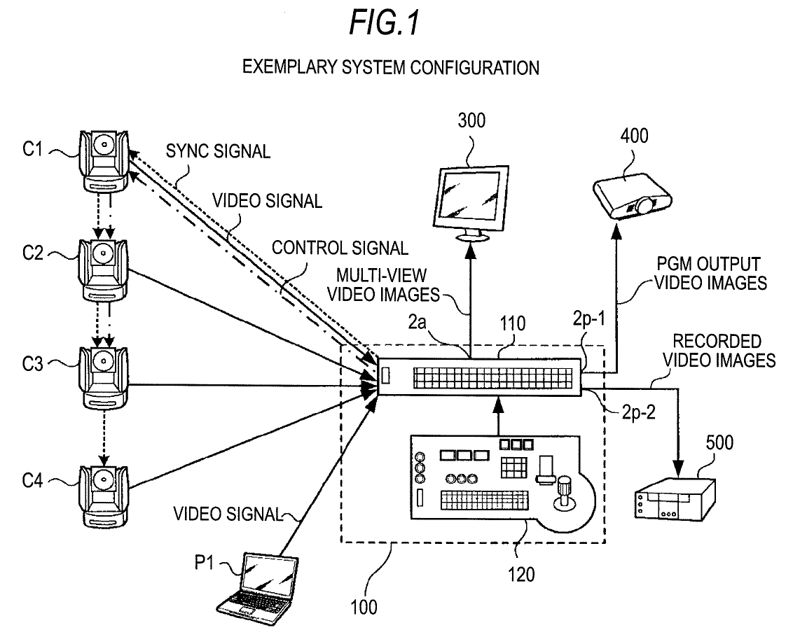

A first embodiment of the invention will first be described with reference to FIGS. 1 to 9.

[Exemplary System Configuration]

FIG. 1 shows an exemplary configuration of a system according to the present embodiment. The system shown in FIG. 1 includes a video signal processing apparatus 100 having a video switcher function and a camera control function. The video signal processing apparatus 100 is formed of a main unit 110 and an operation input unit 120. While the main unit 110 and the operation input unit 120 are separate units in the present embodiment, they may be integrated with each other. The video signal processing apparatus 100 of the present example is used not only as a video switcher but also as a camera control apparatus capable of performing camera control.

The video signal processing apparatus 100 is a portable apparatus and used to, for example, relay events that take place in a large lecture hall, a large conference room, a live concert hall, and any other similar place and produce video content that introduces how the events have proceeded.

The main unit 110 shown in FIG. 1 is connected to four cameras C1 to C4 and a personal computer (hereinafter referred to as a PC) P1 as sources from which video images are inputted.

The cameras C1 to C4 are connected to SDI (Serial Digital Interface) input terminals (not shown) or any other suitable terminals of the main unit 110, and video images captured by the cameras C1 to C4 are inputted to the main unit 110 via the respective input terminals. The image capturing operation in the cameras C1 to C4 is synchronized with a sync signal supplied from the main unit 110.

Each of the cameras C1 to C3 is provided with a serial interface based on the VISCA® protocol or any other suitable protocol and connected to the main unit 110 via a serial cable (not shown) for control signal transfer. That is, the main unit 110 can control the cameras C1 to C3 by supplying control signals (camera control commands) thereto. An ACK message or any other similar response from each of the cameras C1 to C3 is also sent over the corresponding serial cable to the main unit 110.

The camera C4 is connected to the main unit 110 via a DVI (Digital Visual Interface) cable or any other suitable cable, and video images captured by the camera C4 are transferred to the main unit 110 through a DVI input terminal (not shown). The camera C4, which does not have any terminal to which a control signal from the main unit 110 is inputted, is not controllable by the main unit 110.

The PC P1 is connected to another DVI input terminal, an RGB input terminal (not shown), or any other suitable terminal of the main unit 110 and inputs still images, motion images, or any other images stored in an HDD (Hard Disk Drive, not shown) or any other storage to the main unit 110.

The main unit 110, which has the video switcher function and the camera control function as described above, switches the output video image between a PGM output video image and a NEXT output video image in the video switcher function mode in which the main unit 110 functions as a video switcher, whereas the main unit 110 controls the cameras under control in the camera controller mode in which the main unit 110 functions as a camera controller. The configuration of the main unit 110 will be described later in detail.

The main unit 110 is connected to a destination to which video images are outputted from the main unit 110, for example, a display device 300 formed of an FPD (Flat Panel Display) or any other suitable component, a projector 400, and a recording device 500 formed of an HDD or any other suitable component. In the example shown in FIG. 1, the projector 400 is connected to a PGM output terminal 2p-1 of the main unit 110, and PGM output video images are outputted to the projector 400. The display device 300 is connected to an AUX output terminal 2a of the main unit 110, and video images arranged in the multi-view display format (hereinafter referred to as multi-view video images) or other images are outputted to the display device 300. The recording device 500 is connected to a PGM output terminal 2p-2 of the main unit 110, and records a video signal outputted from the main unit 110 as recorded video images.

The operation input unit 120 connected to the main unit 110 transmits an operation signal according to an operation performed by a user to a control section, which will be described later, in the main unit 110. For example, instructions to switch video images outputted from the main unit 110 are issued from the operation input unit 120.

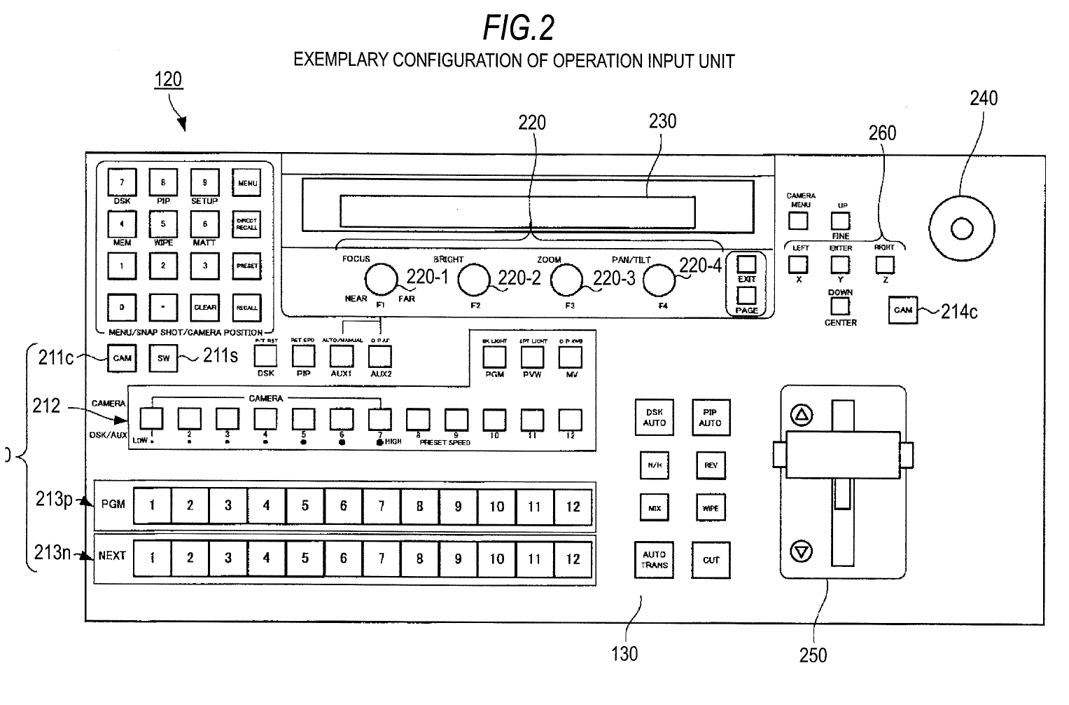

An exemplary configuration of the operation input unit 120 will be described with reference to FIG. 2. The operation input unit 120 shown in FIG. 2 includes an operation button section 210 formed of a variety of buttons, a dial section 220 formed of four dials, and a display section 230. The operation input unit 120 further includes a joy stick 240 and a transition lever 250 on an operation panel 130.

The operation button section 210 includes a first camera mode switching button 211c and a switcher mode switching button 211s as function selectors, AUX output selection/camera selection buttons 212, PGM selection buttons 213p, and NEXT selection buttons 213n.

The first camera mode switching button 211c switches the mode setting in the main unit 110 from the video switcher function mode to the camera controller mode. The switcher mode switching button 211s switches the mode setting from the camera controller mode to the video switcher function mode. The actual mode switching operation is carried out in a control section 60, which will be described later, when either of the switching buttons is pressed.

In the present embodiment, a second camera mode switching button 214c is disposed to the lower left of the joy stick 240. The first and second camera mode switching buttons 211c and 214c function identically. The first camera mode switching button 211c and the switcher mode switching button 211s are also collectively referred to as “switching buttons.”

A lamp (an LED, for example) built in each of the switching buttons shows which function mode is enabled. The user can therefore immediately know that the current function mode is the video switcher function mode or the camera controller mode. When the video switcher function mode is chosen, the joy stick 240 is used to position a slave image relative to a master image in a PinP (Picture in Picture). On the other hand, when the camera controller mode is chosen, the joy stick 240 is used to control a selected one of the cameras (perform pan/tilt/zoom control). In this case, the joy stick 240 outputs a first operation signal that instructs the camera to control pan or tilt thereof in accordance with the amount of displacement of the joy stick 240.

The first camera mode switching button 211c is disposed on the left side of the operation panel 130, and the second camera mode switching button 214c is disposed on the right side. In this arrangement, the user can switch to the camera controller mode with either of the right and left hands in the shortest distance. Further, each of the first and second camera mode switching buttons 211c and 214c is disposed in a position close to the center position of the corresponding one of both hands of the user who operates the operation panel 130. Since the user can thus operate the operation panel 130 with both hands, the operability is improved.

The AUX output selection/camera selection buttons 212 function as AUX output selection buttons in the video switcher function mode, whereas functioning as camera selection buttons in the camera controller mode. Logical numbers 1 to 12 are assigned to the AUX output selection/camera selection buttons 212. The buttons labeled with 1 to 12 are enabled when the video switcher function mode is chosen, whereas only the buttons labeled with 1 to 7 are enabled when the camera controller mode is chosen.

When the AUX output selection/camera selection buttons 212 function as the AUX output selection buttons, and any of the selection buttons is pressed, a video signal inputted through the input port related in advance to the logical number assigned to the pressed button is outputted to the AUX output terminal 2a. In the example shown in FIG. 1, since the display device 300 is connected to the AUX output terminal 2a, video images inputted through the input port related to the logical number described above are displayed on the screen of the display device 300.

When the AUX output selection/camera selection buttons 212 function as the camera selection buttons, video images inputted from the camera under control that is related in advance to the logical number selected by a button pressing operation are outputted through the AUX output terminal 2a. The video images captured by the selected camera under control and outputted through the AUX output terminal 2a are displayed on the screen of the display device 300.

The PGM selection buttons 213p determine which one of the video signals inputted from the cameras C1 to C4, the PC P1, and any other apparatus connected to the main unit 110 is selected as the PGM output. The NEXT selection buttons 213n determine which one of the video signals inputted to the main unit 110 is selected as the NEXT output.

The same logical numbers 1 to 12 as those assigned to the AUX output selection/camera selection buttons 212 are also assigned to the PGM selection buttons 213p and the NEXT selection buttons 213n. For example, when any of the PGM selection buttons 213p is pressed, the video signal inputted through the input port related in advance to the logical number selected by the button pressing operation is selected as the PGM output. The PGM selection buttons 213p and the NEXT selection buttons 213n are designed to function as a video switcher irrespective of whether the video switcher function mode or the camera controller mode is chosen.

The logical numbers are also related to the positions where video images are displayed on the multi-view display screen. The relating operation allows the logical numbers 1 to 12 assigned to the PGM selection buttons 213p or the NEXT selection buttons 213n, the camera numbers, and the display positions on the multi-view display screen to be related to each other in a one-to-one relationship. The relating operation is carried out in advance by the user.

The dial section 220 is formed of four dials, a dial 220-1 to a dial 220-4. When the camera controller mode is chosen, the dial 220-1 functions as a dial for adjusting the focus of any of the cameras under control. The dial 220-2 functions as a dial for adjusting the brightness. The dial 220-3 functions as a dial for adjusting the zoom. The dial 220-4 functions as a dial for adjusting the pan and tilt.

The dial section 220 outputs a second operation signal that limits the speed at which any of the cameras is moved in accordance with the amount of displacement. The operation control signal outputted from the dial section 220 limits the speed at which any of the cameras is moved to a value smaller than the fastest camera movement speed. This means that when the range of the camera movement speed is divided into 25 steps with a slowest speed of zero and a fastest speed of 24, the camera movement speed is limited by controlling the dial section 220, for example, to a value within a range from the slowest speed of zero to the fastest speed of 10.

When the video switcher function mode is chosen, the dials 220-1 to 220-4 function as dials for adjusting the functions assigned to functions F1 to F4.

The display section 230 is formed of a VFD (Vacuum Fluorescent Display) or any other suitable component and displays the setting of an effect exerted on a video image when the video image is switched to another, a setting menu used to set the cameras under control, and other items.

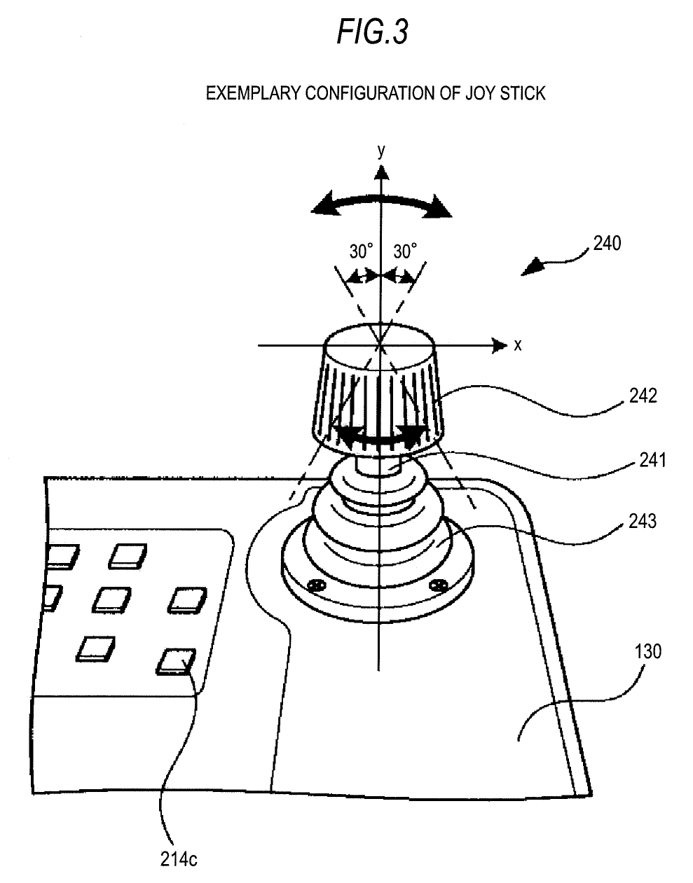

The joy stick 240 is formed of a lever 241 supported pivotally in X-axis, Y-axis and Z-axis directions and a knob 242 provided on the upper end of the lever 241 (See FIG. 3, which will be described later). When the camera controller mode is chosen, the amounts of pan, tilt, and zoom control of any of the connected cameras can be specified by inclining the lever 241 or rotating the knob 242. When the video switcher function mode is chosen, the on-screen position of a PinP inserted in a PGM output video image can be determined by inclining the lever 241.

The transition lever 250 is an operation member shiftable in the up/down direction, and continuously changes a video image to another in accordance with the amount of shift in the up/down direction. The transition lever 250 is also designed to operate in the same manner (operate as a video switcher) irrespective of whether the video switcher function mode or the camera controller mode is chosen.

Menu setting buttons 260 are used when the display device 300 displays a camera menu (not shown). The camera menu allows the user to make an initial setting for each of the cameras C1 to C3.

As described above, operating a relevant one of the switching buttons disposed on the operation panel 130 allows the function mode to be switched appropriately for effective use of the video signal processing apparatus 100. In the present embodiment, the transition lever 250, an input cross point section 20 to which video signals are inputted and an output cross point section 40 from which a video signal is outputted are designed to be always operable. A video image can therefore be switched to another even when any camera control is being performed. The transition lever 250, the first camera mode switching button 211c, and the switcher mode switching button 211s only perform the respective dedicated functions assigned thereto. Therefore, even when the video signal processing apparatus 100 is operated in the camera controller mode, the main video image can be switched to another.

Each of the transition lever 250, the first camera mode switching button 211c, and the switcher mode switching button 211s has only one function assigned thereto. On the other hand, each of the other operation sections performs a certain function in the camera controller mode and another function in the video switcher function mode. For example, a plurality of functions according to function modes to be selected are assigned to each of the AUX output selection/camera selection buttons 212 and the joy stick 240. As a result, the number of switches, buttons, and other components can be reduced, and hence the area of the operation panel 130 can be reduced, but the user can still switch a video image to another while performing any camera control. Further, the production cost of the video signal processing apparatus 100 and the operation input unit 120 can be lowered.

When the first camera mode switching button 211c is pressed, the video output is also switched in response thereto. In this process, when a camera on which the user wants to perform camera control is specified, a video signal that has been related in advance is outputted through the AUX output. Further, the menu displayed on the display section 230 can be used to enable or disable the action of switching the video output in response to the operation of the first camera mode switching button 211c.

In the video signal processing apparatus 100, the camera numbers (camera IDs) and the input source numbers (terminal) are related to each other in advance. When an input source number to which video images captured by the camera that the user wants to control are inputted is selected on the apparatus side, the video signal produced by the camera that the user wants to control can be outputted through the AUX output. Therefore, when a camera that the user wants to control is selected, the video signal outputted from the camera can be displayed on the display device 300. For example, when the user wants to “operate the camera C3” and presses the “third” AUX output selection/camera selection button 212 corresponding to the camera C3, video images outputted from the camera C3 are displayed on the display device 300. This enhances the convenience to the user because pressing an AUX output selection/camera selection button 212 readily provides the corresponding video output.

As described above, the operation input unit 120 allows the user to control both the video switcher function and the camera control function by pressing a relevant one of the operation buttons disposed on the single operation panel 130. Further, the joy stick 240, which has been used in a video switcher of related art to position a PinP (Picture in Picture) , is also used to perform camera control (pan/tilt/zoom). Moreover, the video signal processing apparatus 100 allows the user to operate a single camera arbitrarily selected from a plurality of controllable cameras equipped with a PTZ (pan/tilt/zoom) function. Any operation of the cameras that have not been selected is disabled so that no camera control is performed. In this case, no camera command can be transmitted to the cameras that have not been selected, or the cameras that have not been selected are not allowed to receive a camera control command.

When the first camera mode switching button 211c is pressed, the mode of the apparatus transitions to the camera controller mode. When the user presses a key, a control command corresponding to the pressed key is issued to the selected one of the cameras C1 to C3. Specifically, the control command is sent to the selected one of the cameras C1 to C3 via RS-232C or RS-422. Further, incorporating a network terminal or any other suitable component in the video signal processing apparatus 100 allows the user to operate the cameras C1 to C3 by using a communication protocol different from the communication protocol used to send the control command described above.

When the video switcher function and the camera control function are integrated in related art, function switching is used to reduce the number of buttons as much as possible. In contrast, part of the video switcher function is intentionally assigned to buttons operable irrespective of which function mode is selected. In this way, the user can switch a video image to another while performing camera control, although the number of operation buttons is slightly increased. For example, the PGM selection buttons 213p and the NEXT selection buttons 213n perform the video switcher function also in the camera controller mode. The user can therefore operate the cameras C1 to C3 and perform video switching at the same time.

The joy stick 240 is more frequently used to control pan/tilt/zoom in the camera control function than used to position a PinP. To this end, only the second camera mode switching button 214c may be disposed in the vicinity of the joy stick 240 so that the mode of the apparatus can be readily switched to the camera controller mode.

An exemplary external configuration of the joy stick 240 will be described with reference to FIG. 3.

First, assume an xy plane parallel to the operation panel 130. The joy stick 240 includes the lever 241, which issues an instruction, for example, for movement in an arbitrary direction when the lever 241 is inclined to the xy plane by a predetermined angle, and the knob 242, which performs zoom or other control in any of the cameras C1 to C3 when the knob 242 is rotated. The joy stick 240 further includes a fulcrum 243 that connects the lever 241 to the operation panel 130 and works as a fulcrum for the lever 241. The knob 242 issues an operation signal according to the angle of rotation, and the control section 60 reads the operation signal and performs zoom control in the selected camera. The relationship between the rotating direction and the zooming direction can be set by a user's operation of the setting menu (not shown) in advance.

The knob 242 is rotatable around the center of the lever 241 in the y direction within a range from +30 degrees to −30 degrees, and the angle of rotation of the knob 242 is related to the zoom function, which is one of the camera control functions. For example, when the knob 242 is rotated clockwise, the zoom factor of the selected camera is changed toward the telescopic side, whereas when the knob 242 is rotated counterclockwise, the zoom factor of the selected camera is changed toward the wide-angle side. The relationship between the direction in which the knob 242 is rotated and the zooming direction described above may be reversed. The user can arbitrarily set the relationship.

The direction in which the lever 241 is inclined is defined as follows: The x direction is assigned to the pan direction, and the y direction is assigned to the tilt direction. The pan and tilt directions are also defined arbitrarily in accordance with user's preference, as in the zooming direction.

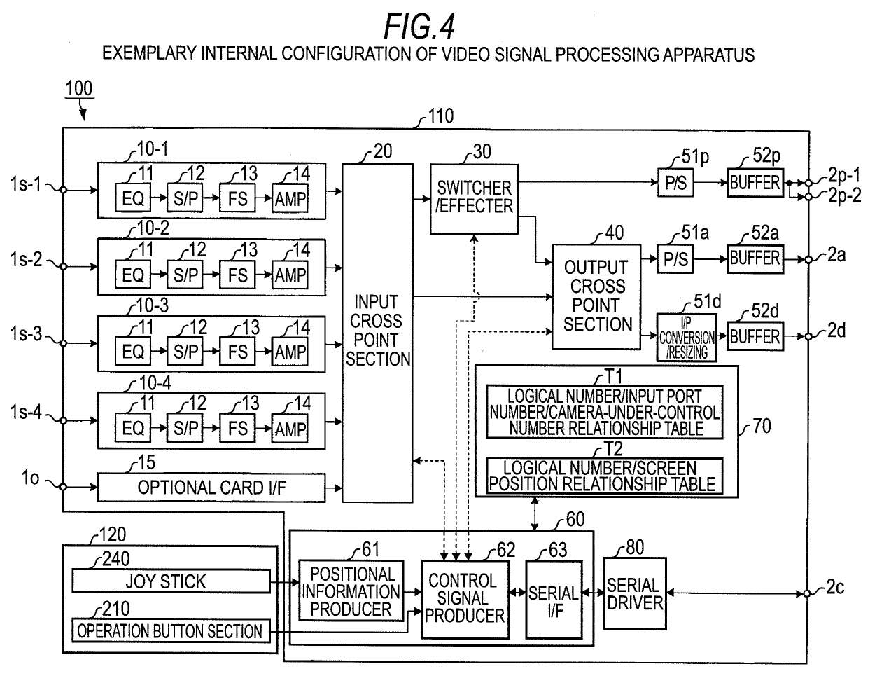

An exemplary internal configuration of the main unit 110 will be described with reference to FIG. 4. In FIG. 4, the portions corresponding to those in FIGS. 1 and 2 have the same reference characters. The main unit 110 includes an SDI interface (hereinafter referred to as an I/F) 10-1 to an SDI I/F 10-4 and an optional card I/F 15 as input sections. The SDI I/F 10-1 to SDI I/F 10-4 include four respective SDI input terminals 1s-1 to 1s-4, to each of which an HD-SDI or SD-SDI signal is inputted. According to the configuration shown in FIG. 1, the video signals outputted from the cameras C1 to C4 are inputted to the SDI I/F 10-1 to SDI I/F 10-4. The video signals outputted from cameras the operation of each of which is controllable are inputted to the SDI input terminals 1s-1 to 1s-3. The video signal outputted from an apparatus the operation of which is not controllable is inputted to the SDI input terminal 1s-4.

Each of the SDI I/F 10-1 to SDI I/F 10-4 includes an equalizer (EQ) 11, a serial/parallel converter (S/P) 12, a frame synchronizer (FS) 13, and an amplifier (AMP) 14.

The equalizer 11 shapes the waveform of an inputted HD/SD-SDI signal and supplies the signal having undergone the waveform shaping to the serial/parallel converter 12. The serial/parallel converter 12 converts the HD/SD-SDI serial signal supplied from the equalizer 11 into a parallel signal and outputs it to the frame synchronizer 13. The frame synchronizer 13 supplies the inputted parallel video signal to the amplifier 14 in synchronization with a reference sync signal in the main unit 110. The amplifier 14 amplifies the inputted video signal to an appropriate magnitude and supplies it to the input cross point section 20 as an input selector.

The optional card I/F 15 is an I/F into which an optional card is inserted. An optional card is a card that is not assembled at the time of factory shipment but adds a function that is not implemented as a standard function. A variety of optional cards are available, such as a card with an analog video signal input terminal, a card with a DVI input terminal, and a card with an HD/SD-SDI input terminal. In the main unit 110 according to the present embodiment, any two of the cards described above at the maximum can be connected to the optional card I/F 15. Therefore, a plurality of video signal terminals are present on the optional card I/F 15. FIG. 4 however collectively shows these terminals in the form of an input video terminal 10 to simplify the description.

In the configuration shown in FIG. 1, the optional card I/F 15 receives a video signal from the PC P1 connected to the terminal of an optional card inserted into the optional card I/F 15. Processing operations according to the type of the inserted card are carried out in the optional card I/F 15, which then outputs the processed video signal to the input cross point section 20. The type of the inputted signal is not limited to those described above, but cards with other types of input terminals may be incorporated.

The input cross point section 20 selects only the video signal selected by the user through an input video image selection operation performed on the operation input unit 120 among a plurality of video signals supplied through the SDI I/F 10-1 to SDI I/F 10-4 and the optional card I/F 15, and outputs the selected video signal. For example, when the first PGM selection button 213p on the operation input unit 120 is pressed, the input cross point section 20 selects the video signal inputted through the input port related to the logical number 1 as the PGM output. That is, the input cross point section 20 relates the inputted video image to any of the NEXT output, the AUX output, the PinP output, the multi-view output, and any other suitable output and then outputs the video image.

When the video signal selected by the input cross point section 20 needs to be processed, for example, when an effect needs to be exerted on the selected video signal, the video signal is supplied to a switcher/effecter 30 as a screen producer. The switcher/effecter 30, for example, selects an input video image and exerts an effect on a video signal.

The switcher/effecter 30 also produces a frame for displaying a PinP image and frames used in the multi-view display format. When frames used in the multi-view display format are produced, the frame for displaying a PGM output video image, the frame for displaying a NEXT output video image, and the frames for displaying video images captured by the cameras under control are produced in such a way that the colors of the frames differ from one another. Processes performed in the switcher/effecter 30 are controlled based on a control signal produced in a control section 60, which will be described later, based on an input video image selection operation performed on the operation input unit 120.

The video signal processed in the switcher/effecter 30, for example, the video signal on which an effect has been exerted, and selected as the PGM output is supplied to a parallel/serial converter 51p disposed downstream of the switcher/effecter 30. The parallel/serial converter 51p converts the video signal into a serial video signal and outputs it to a buffer 52p. The video signal inputted to the buffer 52p is converted into a signal appropriate for an output operation and then outputted as the PGM output.

The video signal processed in the switcher/effecter 30, for example, the video signal on which an effect has been exerted, is also supplied to the output cross point section 40 along with the frame information and other information produced in the switcher/effecter 30. The output cross point section 40 also receives a video signal selected by the input cross point section 20 as a video signal on which no effect needs to be exerted.

The output cross point section 40 chooses either the AUX output terminal 2a or a DVI output terminal 2d as an output section to which the video signal supplied from the input cross point section 20 and the video signal supplied from the switcher/effecter 30 are outputted. Choosing either the AUX output terminal 2a or the DVI output terminal 2d as the output section is determined based on a control signal produced in the control section 60 based on an input video image selection operation performed on the operation input unit 120.

The video signal selected by the output cross point section 40 as the video signal to be outputted to the AUX output terminal 2a is supplied to a parallel/serial converter 51a disposed downstream of the output cross point section 40 and converted into a serial video signal. The converted serial video signal is supplied to a buffer 52a, where the signal is converted into a signal appropriate for an output operation and then outputted to the AUX output terminal 2a as the AUX output. While the configuration in the present embodiment has only one AUX output terminal, a plurality of AUX output terminals may be provided.

The video signal selected as the video signal to be outputted to the DVI output terminal 2d is supplied to an I/P (Interlace/Progressive) conversion/resizing processor 51d, where the video signal is converted into an interlaced or progressive video signal and the screen size is changed as necessary. The video signal having undergone the adjustment operations described above is outputted to a buffer 52d, where the video signal is converted into a signal appropriate for an output operation and outputted to the DVI output terminal 2d as the DVI output.

The control section 60 is formed of a CPU (Central Processing Unit) and other components and produces control signals for controlling the portions in the apparatus and camera control commands for controlling the cameras under control based on a variety of types of information inputted through the operation input unit 120.

The control section 60 includes a positional information producer 61, a control signal producer 62, and a serial I/F 63. The control section 60 is connected to a memory 70 formed of an EEPROM (Electrically Erasable Programmable Read Only Memory) or any other suitable component.

The positional information producer 61 in the control section 60 receives information on the operation angle inputted from the joy stick 240 on the operation input unit 120 and information indicating on/off of each of the operation buttons that form the operation input unit 120. The positional information producer 61 produces information indicating the position of any of the cameras under control, that is, information indicating the amounts of pan/tilt/zoom control, based on the information on the inputted operation angle of the joy stick 240, and supplies the produced positional information to the control signal producer 62 disposed downstream of the positional information producer 61.

The control signal producer 62 produces a camera control command based on the information on the operation angle inputted from the joy stick 240 on the operation input unit 120 and the information on tables recorded in the memory 70. The control signal producer 62 also produces control signals for controlling the portions in the main unit 110 based on the operation button on/off information inputted through the operation button section 210 and the information contained in the tables recorded in the memory 70.

The control signal producer 62 refers to the tables described above to determine an object to be controlled, produces a control signal directed to the thus determined object to be controlled based on an operation inputted through the operation input unit 120, and supplies the control signal to the object to be controlled. Specifically, the camera control command produced by the control signal producer 62 is transferred to the serial I/F 63 disposed downstream of the control signal producer 62 and converted into a serial signal by the serial I/F 63. The camera control command converted into the serial signal is outputted to a control signal output terminal 2c via a serial driver 80 and transferred to any of the cameras under control via the control signal output terminal.

As described above, in the video signal processing apparatus 100, the video switcher function and the camera control function are integrated, and the communication between the two functions is carried out in the video signal processing apparatus 100. The two functions are not simply integrated, but selecting a camera to be controlled after the video switcher function mode or the camera controller mode is chosen causes output video images from the selected camera to be selected.

To perform camera control in a video switcher of related art, it is necessary to operate a switcher device to display the primary output or the standby output in an actual camera control operation. The video signal processing apparatus 100 of the present example, however, automatically outputs a video signal of interest through the AUX output terminal 2a. Therefore, the PGM output video image or the NEXT output video image is not affected.

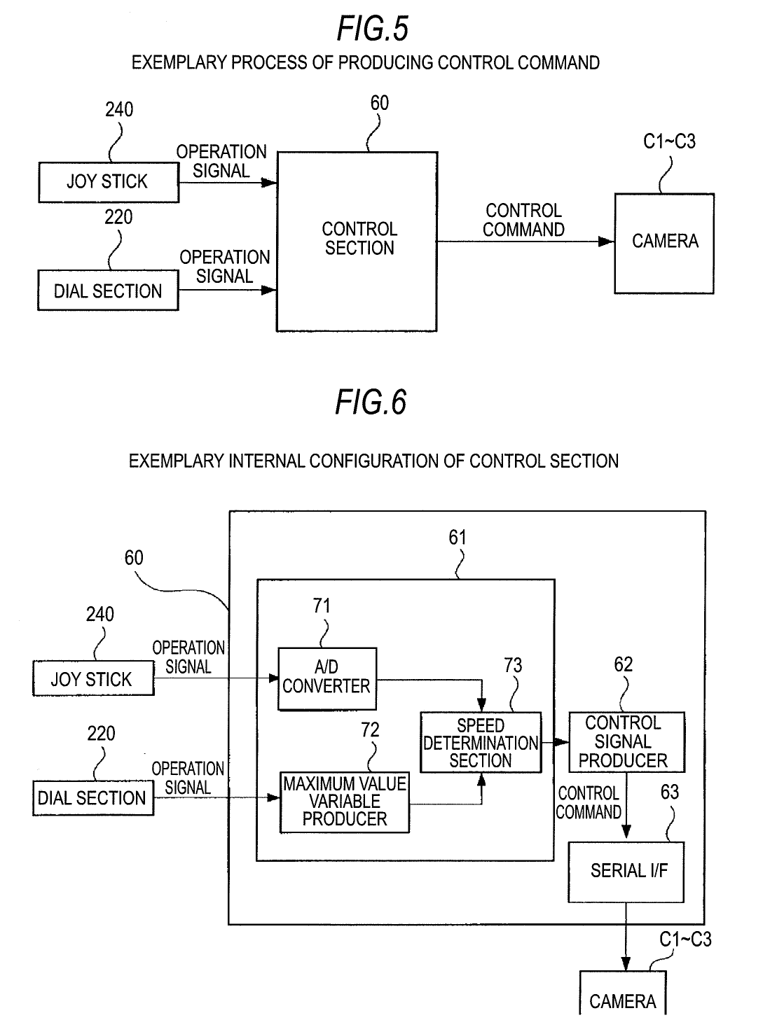

FIG. 5 is a descriptive diagram showing an exemplary process of producing a control command to be sent to the cameras C1 to C3.

The operation signals outputted from the joy stick 240 and the dial section 220 are inputted to the control section 60. The control section 60 produces a speed parameter and a maximum value variable from the inputted operation signals, compares the produced speed parameter and maximum value variable, and produces a control command for controlling the selected one of the cameras C1 to C3. The control section 60 then sends the control command to the selected one of the cameras C1 to C3 via a serial cable for control signal transfer.

FIG. 6 shows an exemplary internal configuration of the control section 60.

The control section 60 includes the positional information producer 61, the control signal producer 62, and the serial I/F 63. The positional information producer 61 includes an analog/digital converter 71 that converts the analog operation signal inputted from the joy stick 240 into a digital operation signal. The positional information producer 61 further includes a maximum value variable producer 72 that produces a digitized maximum value variable that limits the speed at which a camera of interest is moved within a predetermined range based on the analog operation signal (second operation signal) inputted from the dial section 220. The “maximum value variable” produced by the maximum value variable producer 72 is a kind of speed parameter. The positional information producer 61 further includes a speed determination section 73 that determines the speed at which the selected one of the cameras C1 to C3 is moved as the speed parameter in accordance with the first operation signal and based on the digital operation signal and the maximum value variable in such a way that the speed parameter is smaller than or equal to the maximum value variable. An example of how the speed determination section 73 determines the speed at which the selected one of the cameras C1 to C3 is moved will be described later. In FIG. 6, the serial driver 80 shown in FIG. 2 is omitted.

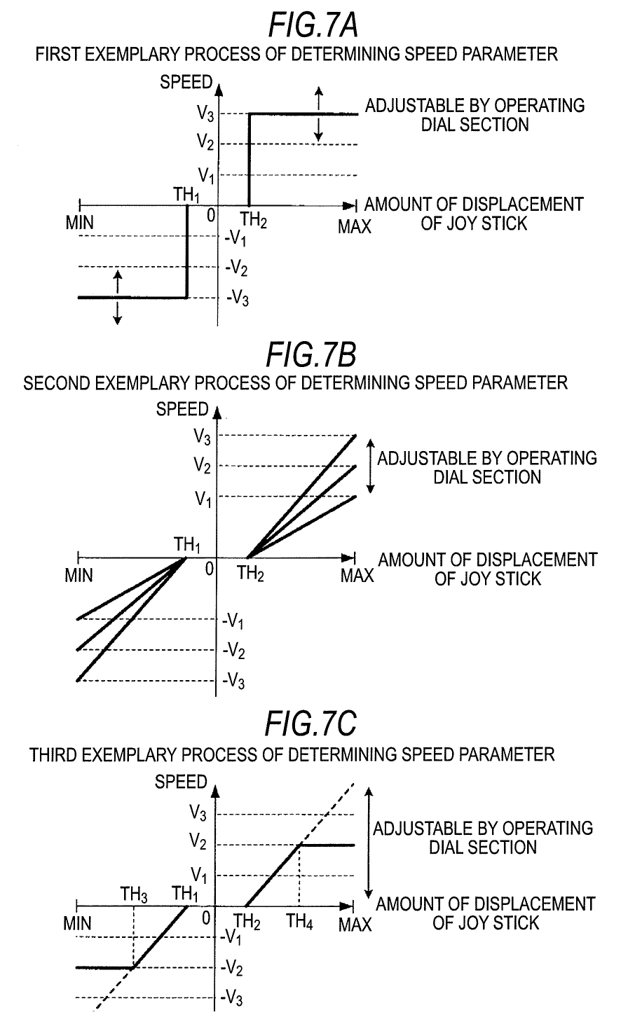

The speed determination section 73 estimates the amount and direction of the displacement of the joy stick 240 based on the digital operation signal supplied from the analog/digital converter 71. In accordance with the estimated amount and direction of the displacement, the speed parameter representing the speed at which the selected one of the cameras C1 to C3 is moved is determined based on a predetermined relationship (see FIGS. 7A to 7C, which will be described later). The speed determination section 73 compares the absolute value of the thus determined movement speed with the absolute value of the maximum value variable supplied from the maximum value variable producer 72, and sends the determined speed parameter having a smaller absolute value to the control signal producer 62. The control signal producer 62 produces a control command based on the speed parameter received from the speed determination section 73 and sends the control command to the selected one of the cameras C1 to C3 via the serial I/F 63.

For example, consider a case where the speed at which the selected one of the cameras C1 to C3 is moved falls within the range from 0 (the camera is moved at the slowest speed or is stationary) to 24 (the camera is moved at the fastest speed). When a joy stick of related art is used to control the speed at which the selected one of the cameras C1 to C3 is moved, and the lever 241 is inclined to its limit, the speed at which the selected one of the cameras C1 to C3 is moved is “24”.However, the maximum speed at which the selected one of the cameras C1 to C3 is moved can be set at “10” in advance by operating the dial section 220. In this case, the movement speed is fixed at “10” even when the lever 241 is inclined to its limit. The speed parameter representing the determined movement speed of “10” is sent to the control signal producer 62, where a control command is produced. When the speed at which the selected one of the cameras C1 to C3 is moved is thus limited, the fastest speed at which the selected one of the cameras C1 to C3 is moved falls within the range from “0” to “10”.

FIGS. 7A to 7C show examples of the speed parameter determined by the speed determination section 73. A description will be made with reference to a case where the speed parameter for moving the camera C1 is determined.

In general, when only the joy stick 240 is used to detect two parameters (vector), the direction and amount of displacement, which are then used to operate a camera, an intermediate displacement value is difficult to create. On the other hand, the speed parameter issued to the camera as a control command is set, for example, at a value that belongs to any of the 25 steps. The speed parameter is determined by the amount of displacement of the joy stick 240, which is determined by the inclination of the lever 241, but it is difficult to keep the lever 241 at a fixed inclination. To keep the camera movement speed fixed, the camera movement speed corresponding to the amount of displacement of the joy stick 240 may need to be limited within a predetermined range.

In FIGS. 7A to 7C, the horizontal axis represents the amount of displacement of the joy stick 240, and the vertical axis represents the determined speed at which the camera C1 is moved. The ends of the horizontal axis shown in FIGS. 7A to 7C are labeled with MIN and MAX. MIN and MAX represent the largest displacements of the joy stick 240. That is, since the motion of the inclined lever 241 is limited by the fulcrum 243, the range within which the joy stick 240 can be moved is from MIN to MAX inclusive. FIGS. 7A to 7C also show threshold values of the speed parameter, which are changed as appropriate by operating the dial section 220. When the amount of displacement of the joy stick 240 falls within the vicinity of the initial position (0), greater than or equal to a threshold value TH₁ but smaller than or equal to a threshold value TH₂, the range is regarded as a dead band, and the speed parameter is determined to be “0”. In this case, the camera C1 is not moved but stationary. In the present example, the threshold values TH₁ and TH₂ are substantially the same. For example, MAX represents the state in which the joy stick 240 is inclined to the rightmost point, and MIN represents the state in which the joy stick 240 is inclined to the leftmost point. That is, the amounts of displacement of the joy stick corresponding to MAX and MIN are positive values. The positive region of the vertical axis represents the speed at which the camera is moved rightward when the joy stick 240 is inclined rightward, whereas the negative region of the vertical axis represents the speed at which the camera is moved leftward when the joy stick 240 is inclined leftward. The speed parameters for the cameras C2 and C3 are similarly determined.

FIG. 7A shows a first exemplary process of determining the speed parameter.

When the amount of displacement of the joy stick 240 whose initial position value is zero is smaller than a first threshold value (TH₁ or TH₂), the speed determination section 73 sets the speed at which the camera C1 is moved at a first speed (zero in the present example). When the amount of displacement of the joy stick 240 whose initial position value is zero is greater than or equal to the first threshold value (TH₁ or TH₂) , the speed determination section 73 sets the speed at which the camera C1 is moved at a second speed (V₃ in the present example).

In the present example, when the amount of displacement of the joy stick 240 is smaller than or equal to the threshold value TH₁, the camera C1 is moved at a fixed speed −V₃. On the other hand, when the amount of displacement of the joy stick 240 is greater than or equal to the threshold value TH₂, the camera C1 is moved at a fixed speed V₃. Adjustment of the speed is carried out, for example, by rotating the dial section 220, and the speed can be any value ranging from V₁ to V₃.

FIG. 7B shows a second exemplary process of determining the speed parameter.

When the amount of displacement of the joy stick 240 whose initial position value is zero is smaller than a first threshold value (TH₁ or TH₂), the speed determination section 73 sets the speed at which the camera C1 is moved at a first speed (zero in the present example). When the amount of displacement of the joy stick 240 whose initial position value is zero is greater than or equal to the first threshold value (TH₁ or TH₂) , the speed determination section 73 changes the speed at which the camera C1 is moved in proportion to the amount of displacement of the joy stick 240.

That is, the dial section 220 determines the maximum speed (limit) , and the joy stick 240 determines a vector having direction and speed components. That is, even when the joy stick 240 is displaced by the maximum amount, the movement speed is limited to a certain value. The speed parameter is determined based on a linear graph expressed by y=ax+b. In this case, the slope “a” is adjusted by operating the dial section 220. The intercept “b” is determined in advance by manipulating the menu or any other suitable method.

For example, when the amount of displacement of the joy stick 240 is smaller than or equal to the threshold value TH₁, the camera C1 is moved at a fixed speed −V₃. On the other hand, when the amount of displacement of the joy stick 240 is greater than or equal to the threshold value TH₂, the camera C1 is moved at a fixed speed V₃.

FIG. 7C shows a third exemplary process of determining the speed parameter.

When the amount of displacement of the joy stick 240 whose initial position value is zero is smaller than a first threshold value (TH₁ or TH₂), the speed determination section 73 sets the speed at which the camera C1 is moved at a first speed (zero in the present example). When the amount of displacement of the joy stick 240 whose initial position value is zero is greater than or equal to the first threshold value (TH₁ or TH₂) but smaller than a second threshold value (TH₃ or TH₄), the speed determination section 73 changes the speed at which the camera is moved in proportion to the amount of displacement of the joy stick 240. When the amount of displacement of the joy stick 240 is greater than or equal to the second threshold value (TH₃ or TH₄), the speed determination section 73 sets the speed at which the camera C1 is moved at a second speed.

When the amount of displacement of the joy stick 240 is smaller than or equal to the threshold value TH₁, the camera C1 is moved at a fixed speed −V₃. On the other hand, when the amount of displacement of the joy stick 240 is greater than or equal to the threshold value TH₂, the camera C1 is moved at a fixed speed V₃.

In the present example, the speed is fixed even when the angle of the joy stick 240 is changed, and the dial section 220 is used to adjust the maximum speed (limit). Therefore, the speed does not increase even when the lever 241 is inclined by an angle greater than or equal to a fixe value. The speed parameter is determined based on a linear graph expressed by y=ax+b. However, when the amount of displacement of the joy stick 240 is smaller than or equal to the threshold value TH₃ or greater than or equal to the threshold value TH₄, the slope “a” is zero, and the camera C1 is moved at a fixed speed. The threshold values TH₃ and TH₄ are adjusted by operating the dial section 220.

One of the components of the vector (direction and controlled speed) detected by the joy stick 240, the direction in which the camera is moved, is determined by the direction in which the joy stick 240 is inclined. The other component of the vector, the speed at which the camera is moved, is limited by operating the dial section 220. The speed at which the camera is moved can therefore be fixed without having to incline the lever 241 by the maximum amount. The difference between the speed parameters V₁ and V₂ may be increased by rotating the knob 242 while pressing the dial section 220.

As described above, in accordance with user's preference, the user can choose to operate only the joy stick 240 with one hand or operate the joy stick 240 and the dial section 220 in combination by using both hands.

When the camera is operated based on the relationship shown in FIG. 7A or 7C, the ratio of the panning speed to the tilting speed is changed when the dial section 220 is operated. As a result, the camera is moved in a way that is not expected by the user in some cases. In this case, for example, the camera may not be moved in the direction in which the lever 241 is inclined. In this state, when the lever 241 is inclined in a diagonally upper right direction, the camera C1 is moved only in the direction corresponding to 45 degrees because the ratio of the speed parameter in the pan direction to the speed parameter in the tilt direction is always one. When the camera is operated based on the relationship shown in FIG. 7B, the ratio of the speed in the pan direction to the speed in the tilt direction is maintained.

Consider now that the camera is moved in the two directions, the pan/tilt directions, simultaneously based on the relationship shown in FIG. 7A. When the speed parameters in the pan/tilt directions are the same, the camera C1 is moved only in one direction. As a result, the user may not be able to control the direction in which the camera C1 is moved.

To address the problem described above, the speed parameters in the two (pan/tilt) directions in which the camera C1 is moved are designed to follow a master-slave relationship, and only the master parameter is controlled by the dial section 220. The operation signal supplied from the joy stick 240 is used to determine the ratio between the speed parameters in the two directions. The ratio between the speed parameters in the two (pan/tilt) directions is used to calculate the master and slave parameters. In this way, the user uses the dial section 200 to change the speed parameters without any strange feeling.

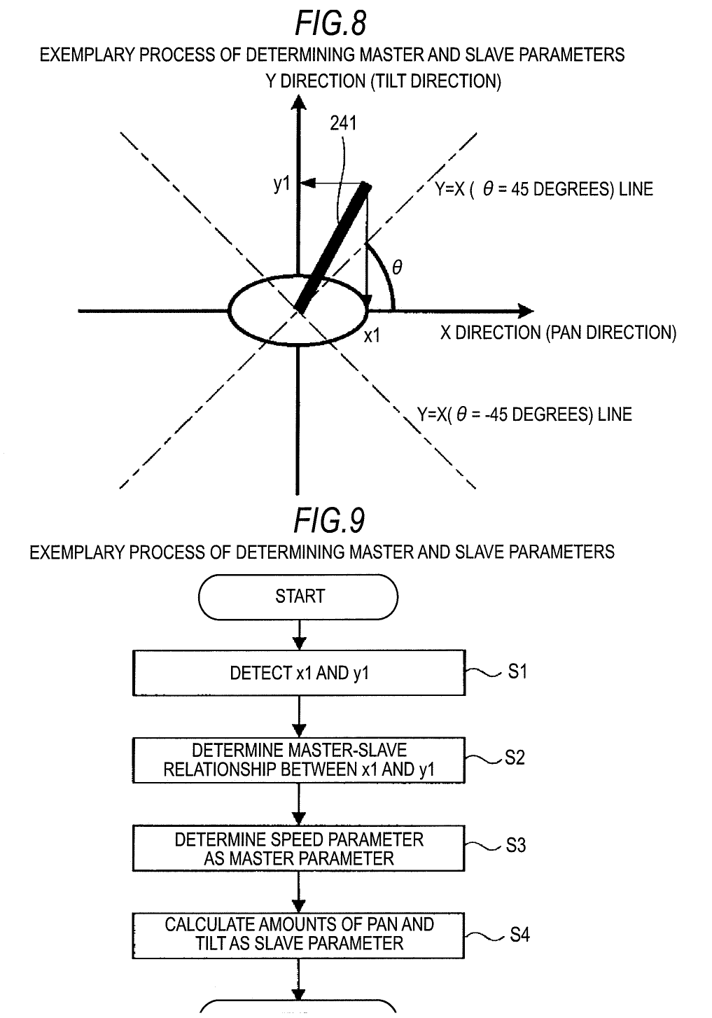

FIG. 8 is a model diagram from which the x and y directions are determined when the joy stick 240 (lever 241) is inclined.

The speed determination section 73 separates the amount and direction of displacement of the joy stick 240 into the components in two axes. When the amount of displacement projected on a first axis is greater than or equal to the amount of displacement projected on a second axis, the direction in which the camera is moved is determined to be the first axis based on the amount of displacement projected on the first axis. The pan or tilt of the camera is then determined based on the amount of displacement projected on the second axis.

On the other hand, when the amount of displacement projected on the first axis is smaller than the amount of displacement projected on the second axis, the direction in which the camera is moved is determined to be the second axis based on the amount of displacement projected on the second axis. The pan or tilt of the camera is then determined based on the amount of displacement projected on the first axis.

In the present example, let an X axis be the first axis and a Y axis be the second axis, and the first and second axes intersect at right angles at the center of the fulcrum 243. Alternatively, the first and second axes may be set in such a way that they intersect at an arbitrary angle. The speed determination section 73 judges which direction is considered as the master parameter, the pan direction or the tilt direction, by using the line that satisfies Y=X (θ=45 degrees) as the boundary. When the tilt direction is assigned to the master parameter, the maximum value variable is determined by the dial section 220. In this case, the pan direction is determined by x1 and y1, which are values read from the operation signal from the joy stick 240.

The slave parameter is calculated in the form of the ratio of the master parameter controlled by the dial section 220 to the value determined from the ratio between the operation signals in the two directions detected by the joy stick 240 (speed parameters in the pan/tilt directions). To calculate the ratio, it is necessary to operate the camera by using one of the pan/tilt speed parameters as the master parameter and the other speed parameter as the slave parameter. To this end, the speed determination section 73 detects a displacement parameter detected from the joy stick 240 (operation signal that correlates with the two-dimensional x and y coordinates) and judges which of the following relationships is satisfied: |x|≧|y| or |x|<|y|. When |x|≧|y| is satisfied, the speed parameter in the pan direction corresponding to x is considered as the master parameter, and the dial section 220 is used to adjust the maximum value variable. The speed parameter in the tilt direction corresponding to y is considered as the slave parameter. The master parameter multiplied by y/x is employed as the speed parameter in the tilt direction.

On the other hand, when |x|<|y| is satisfied, the speed parameter in the tilt direction corresponding to y is considered as the master parameter, and the dial section 220 is used to adjust the maximum value variable. The speed parameter in the pan direction corresponding to x is considered as the slave parameter. The master parameter multiplied by x/y is employed as the speed parameter in the pan direction. As shown in FIG. 8, the master-slave relationship between the speed parameters may be judged by using θ=45 degrees as the boundary.

The speed determination section 73 sets the x direction as the master parameter and the y direction as the slave parameter when the inclination 0 of the lever 241 projected onto the xy plane to the x direction satisfies the following expression: 0 degrees≦θ<45 degrees. When 45 degrees≦θ<90 degrees is satisfied, the x direction is set as the slave parameter and the y direction is set as the master parameter. When 90 degrees≦θ<135 degrees is satisfied, the x direction is set as the slave parameter and the y direction is set as the master parameter. When 135 degrees≦θ<180 degrees is satisfied, the x direction is set as the master parameter and they direction is set as the slave parameter. When 180 degrees ≦θ<225 degrees is satisfied, the x direction is set as the master parameter and the y direction is set as the slave parameter. When 225 degrees≦θ<270 degrees is satisfied, the x direction is set as the slave parameter and the y direction is set as the master parameter. When 270 degrees≦θ<315 degrees is satisfied, the x direction is set as the slave parameter and the y direction is set as the master parameter. When 315 degrees≦θ<360 degrees is satisfied, the x direction is set as the master parameter and the y direction is set as the slave parameter.

When the speed parameters are determined based on the relationship shown in FIG. 7C, as in the case described above, the relationship between the master and slave parameters corresponding to the pan and tilt (hereinafter sometimes simply referred to as a “master-slave relationship”) is calculated from the direction in which the joy stick 240 is displaced. The camera is driven with the ratio of the speed in the pan direction to the speed in the tilt direction kept constant. Further, the dial section 220 is used to determine the maximum value variable of the speed parameter as the master parameter, and the slave parameter is equivalent to the speed parameter determined in accordance with the inclination of the lever 241. In other words, determining the slave parameter is equivalent to adapting the amount of displacement and the movement speed of the joy stick 240 to the direction in which the lever 241 is inclined.

That is, when the joy stick 240 is inclined in an oblique direction, the speed parameter in the direction determined by the master parameter is produced by the dial section 220, and the speed parameter in the direction determined by the slave parameter is produced from the amount of displacement of the joy stick 240. In this way, the dial section 220 can be used to change the movement speed with the ratio between the directions in which the joy stick 240 is moved kept constant.

FIG. 9 shows an exemplary process of determining the speed parameters in the pan and tilt directions.

First, the speed determination section 73 detects x1 and y1, which are the amounts corresponding to the X and Y directions (voltage of the operation signal, for example) based on the inclination of the joy stick 240 (step S1).

The speed determination section 73 then uses the relationship between x1 and y1 to determine the master-slave relationship between the pan and tilt directions (step S2). The master-slave relationship is determined by judging which is greater, x1 or y1. For example, when x1 is greater than y1, the pan direction is considered as the master parameter, and the tilt direction is considered as the slave parameter. On the other hand, when x1 is smaller than y1, the pan direction is considered as the slave parameter, and the tilt direction is considered as the master parameter.

The speed determination section 73 then determines the speed parameter in the direction judged as the master parameter by using the value inputted from the dial section 220 (step S3). After the master parameter is determined, the slave parameter is determined from x1 and y1 (step S4).

When the pan direction is considered as the master parameter, the speed parameter in the tilt direction, which is considered as the slave parameter, is determined from the relationship of pan:tilt=x1:y1. On the other hand, when the tilt direction is considered as the master parameter, the speed parameter in the pan direction, which is considered as the slave parameter, is determined from the relationship of pan:tilt=x1:y1. The speed parameters in the pan and tilt directions are thus calculated.

According to the present embodiment described above, to operate the camera by using the joy stick 240, a control command for controlling the directions in which pan/tilt/zoom operations are carried out and the speeds at which the operations are carried out is produced in accordance with the direction and amount of displacement from the neutral point. The maximum value variable determined by the angle of rotation of the dial section 220 limits the maximum value of the camera movement speed to control the speed parameter determined by the joy stick 240. The user can thus readily move the camera at a fixed speed. The maximum value variable for the movement speed, which is proportional to the amount of displacement of the joy stick 240, is controlled by the angle of rotation of the dial section 220. It is therefore possible to perform finer control, that is, control at the resolution according to the apparatus, and the user can operate the apparatus with both hands.

The speed determination section 73 prevents the camera from moving when the amount of displacement of the joy stick, that is, the lever 241, fluctuates relative to the initial position (0) within a predetermined threshold value range (TH₁ or TH₂). When the amount of the displacement of the joy stick is greater than or equal to the predetermined threshold value (TH₁ or TH₂), the speed determination section 73 changes the camera movement speed appropriately in accordance with the amount of displacement of the joy stick. As a result the operability of the apparatus operated by the user is advantageously improved.

The speed determination section 73 limits the camera movement speed so that the camera movement speed is smaller than or equal to the maximum camera movement speed. Therefore, even when the joy stick is displaced by the maximum amount, the camera will not be moved abruptly, whereby a subject to be imaged can be advantageously captured in an appropriate manner.

Further, a device different from the joy stick 240 is used to detect the amount of displacement corresponding to the pan/tilt/zoom control speed in any of the cameras C1 to C3, whereby shake or other motion of the operating hand of the user that affects the operation of the joy stick 240 can be removed. Moreover, a lens can be driven at a fixed speed, whereby the zooming operation can be smoothly carried out. Further, since the dial section 220 can determine the speed parameter corresponding to the displacement produced when the joy stick 240 hits a mechanical end, it is not necessary to keep the joy stick 240 in an intermediate displacement position.

When the method in which the dial section 220 controls the speed parameters is used, and one of the speed parameters in the pan and tilt directions is limited, the other speed parameter can be automatically limited by establishing a master-slave relationship between the pan and tilt directions. Therefore, the ratio of the movement speed in the pan direction to that in the tilt direction will not change, whereby the operation of the dial section 220, which controls the speed parameters, does not advantageously change the movement direction.

### 2. Second Embodiment

[Control the speed at which a camera is moved: an exemplary process of carrying out an interrupt process based on a hold button signal]

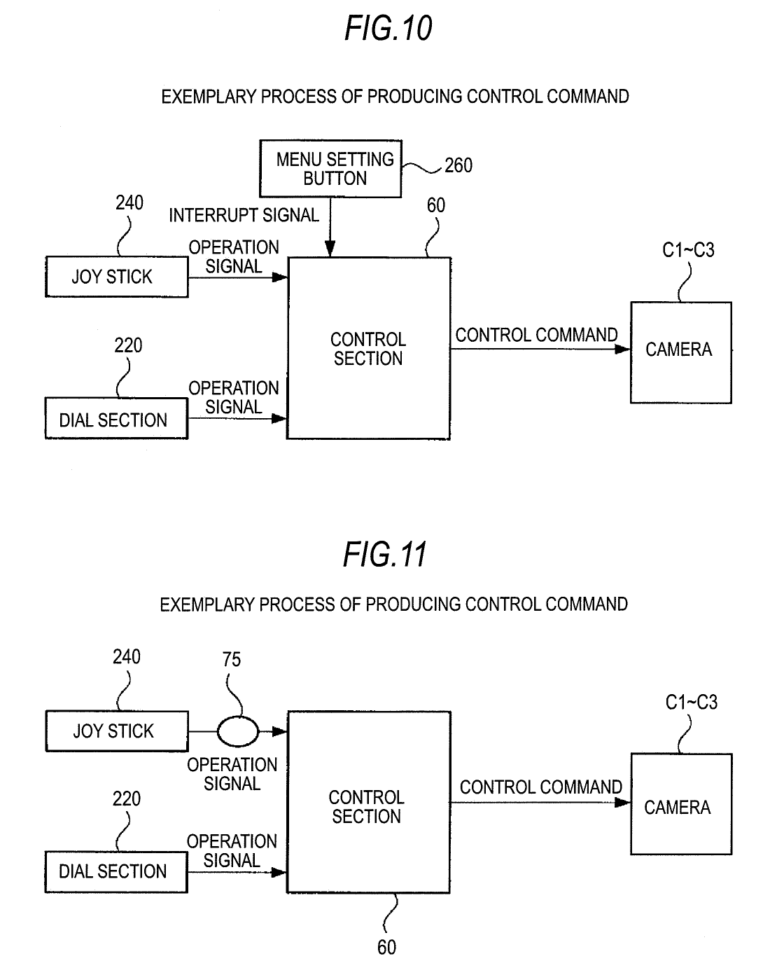

A second embodiment of the invention will be described with reference to FIG. 10. In the following description, the portions corresponding to those in the drawings that have been described in the first embodiment have the same reference characters, and no redundant detailed description of those portions will be made.

To remove the influence of the unstableness of a desired intermediate displacement produced when the lever 241 of the joy stick 240 is inclined, a hold button may be provided as a speed holding section that keeps the speed at which any of the cameras C1 to C3 is moved constant. In this embodiment, the function of the hold button is assigned to any of the menu setting buttons 260 (see FIG. 2). After the menu setting buttons 260 are used to set the cameras C1 to C3, the assigned one of the menu setting buttons 260 also serves as the hold button. Specifically, the assigned one of the menu setting buttons 260 has a function of keeping the speed at which any of the cameras C1 to C3 is moved constant.

The assigned one of the menu setting buttons 260 holds the amount of displacement of the joy stick 240 at the instant when the user presses the assigned one of the menu setting buttons 260. When the assigned one of the menu setting buttons 260 is pressed again, the amount of displacement of the joy stick 240 is not held anymore. In this way, the speed parameter at a certain instant can be held, and the selected one of the cameras can be moved at a fixed speed in a fixed direction.

FIG. 10 shows an exemplary process of producing a control command for controlling the motion of any of the cameras C1 to C3.

The joy stick 240 and the dial section 220 supply operation signals to the control section 60. The assigned one of the menu setting buttons 260 supplies an interrupt signal to the control section 60 at the instant when the assigned one of the menu setting button 260 is pressed. When the control section 60 receives the interrupt signal from the menu setting button 260, the control section 60 temporarily holds the value of the operation signal from the joy stick 240 at the time of reception and uses the thus held value in internal processes. When pressed again, the assigned one of the menu setting button 260 supplies an interrupt signal to the control section 60 again. When the control section 60 receives the interrupt signal again from the menu setting button 260, the control section 60 no more holds the value of the operation signal from the joy stick 240.

According to the second embodiment described above, the operation signal from the joy stick 240 is held when the interrupt signal is supplied from the assigned one of the menu setting buttons 260, which has the function of the hold button. Therefore, the selected one of the cameras is readily moved at a fixed speed, and the operability of the apparatus operated by the user is advantageously improved.

Alternatively, a dedicated button having the function of the hold button may be provided on the operation panel 130.

### 3. Third Embodiment

[Control the speed at which a camera is moved: an exemplary process of extracting low-frequency components from the operation signal outputted from the joy stick]

A third embodiment of the invention will be described with reference to FIG. 11. In the following description, the portions corresponding to those in the drawings that have been described in the first embodiment have the same reference characters, and no redundant detailed description of those portions will be made.

FIG. 11 shows an exemplary process of producing a control command for controlling the motion of any of the cameras C1 to C3.

The joy stick 240 and the dial section 220 supply operation signals to the control section 60. A low-pass filter 75 transmitting low-frequency components lower than or equal to several Hz contained in the operation signal is provided somewhere in the middle of a signal line connecting the joy stick 240 to the control section 60. The low-pass filter 75 is inserted to eliminate the unstableness of an intermediate displacement. The low-pass filter 75 may be replaced with a digital filter logically formed in the control section 60.

When “the amount of unstable displacement” determined from the operation signal supplied from the joy stick 240 is smaller than or equal to a fixed amount (within the range between the threshold values TH₁ and TH₂ in FIGS. 7A to 7C), it is judged that the displacement is caused by human unstableness. The low-pass filter 75, which transmits low-frequency components, for example, components at approximately 10 Hz, is dynamically inserted between the joy stick 240 and the control section 60, whereby the low-frequency components of the first operation signal are transmitted, and the influence of the amount of unstable displacement is removed. Further, the low-pass filter 75 is designed to have a function of averaging the transmitted low-frequency components to remove the influence of small motion of the joy stick 240. In this way, the amount of unstable displacement of the joy stick 240 is averaged, whereby the speed at which any of the cameras is moved can be held at a fixed value, because the rate of change in the operation signal due to human unstableness is, for example, approximately 10 Hz or lower. As described above, inserting the low-pass filter 75, whose cutoff frequency is approximately several Hz, between the joy stick 240 and the control section 60 allows the influence of a false signal produced by human unstableness on the speed parameter to be reduced.

According to the third embodiment described above, providing the low-pass filter 75 that transmits low-frequency components allows the influence of a false signal produced by human unstableness on the speed parameter to be reduced. Therefore, the selected one of the cameras is readily moved at a fixed speed, and the operability of the apparatus operated by the user is advantageously improved. It is noted that averaging the operation signal from the joy stick 240 in the control section 60 will provide the same advantageous effect.

### <4. Variations>

In the embodiments described above, to increase the precision of the operation signal supplied from the joystick 240, the function of the hold button is assigned to any of the menu setting buttons 260, or the low-pass filter 75 is inserted. It is alternatively possible to reduce the influence of the unstableness of the lever 241 by inclining the lever 241 by a largest possible amount. That is, when the lever 241 is inclined to the maximum inclination angle so that the lever 241 almost comes into contact with the operation panel 130, the speed determination section 73 produces a speed parameter corresponding to the maximum value determined by the dial section 220. In this case, the lever 241 will not show unstableness, whereby any of the cameras can be moved at a fixed speed.

The amount and direction of displacement of the joy stick 240 may alternatively be calculated based on the angle θ of the lever 241, the length of the arcuate trajectory of the lever 241, the sinθ-projection according to the inclination of the lever 241, or any other suitable parameter.

In the second and third embodiments described above in which the speed parameter is determined, it is assumed that the speed parameter is determined based on the linear graph expressed by y=ax+b. Alternatively, the speed parameter may be determined by using an exponential function or a logarithmic function instead of the linear graph. The reason why the functions described above are used is that a parameter corresponding to human sensation has in general a logarithmic relationship, as derived from what is called Weber-Fechner's law. As a result, the user can naturally operate the cameras.

The present application contains subject matter related to that disclosed in Japanese Priority Patent Application JP 2008-283628 filed in the Japan Patent Office on Nov. 4, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A camera control apparatus comprising:
a first operation section outputting a first operation signal in accordance with the amount of displacement thereof, the first operation signal instructing a camera to perform pan or tilt control;
a second operation section outputting a second operation signal in accordance with the amount of displacement thereof, the second operation signal limiting the speed at which the camera is moved;
a maximum value variable producer producing a maximum value variable that limits the speed at which the camera is moved within a predetermined range based on the second operation signal;
a speed determination section determining the speed at which the camera is moved in accordance with the first operation signal so that the speed is smaller than or equal to the maximum value variable; and
a control signal producer producing a control command for controlling the direction in which the camera is moved and the speed at which the camera is moved based on the determined speed at which the camera is moved.

2. The camera control apparatus according to claim 1,
wherein the speed determination section sets the speed at which the camera is moved to a first speed when the amount of displacement of the first operation section is smaller than a first threshold value, whereas changing the speed at which the camera is moved in proportion to the amount of displacement of the first operation section when the amount of displacement of the first operation section is greater than or equal to the first threshold value.

3. The camera control apparatus according to claim 2,
wherein the second operation section outputs the second operation signal that limits the speed at which the camera is moved to a value smaller than a maximum speed at which the camera is moved.

4. The camera control apparatus according to claim 3, further comprising a speed holding section holding the speed at which the camera is moved at a fixed value,
wherein the speed holding section holds the amount of displacement of the first operation section at the instant when the speed holding section is pressed, whereas the speed holding section no more holds the amount of displacement of the first operation section when the speed holding section is pressed again.

5. The camera control apparatus according to claim 4, further comprising a low-pass section transmitting low-frequency components of the first operation signal and averaging the low-frequency components.

6. The camera control apparatus according to claim 1,
wherein the speed determination section sets the speed at which the camera is moved to a first speed when the amount of displacement of the first operation section is smaller than a first threshold value, changes the speed at which the camera is moved in proportion to the amount of displacement of the first operation section when the amount of displacement of the first operation section is greater than or equal to the first threshold value but smaller than a second threshold value, and sets the speed at which the camera is moved to a second speed when the amount of displacement of the first operation section is greater than or equal to the second threshold value.

7. The camera control apparatus according to claim 1,
wherein the speed determination section sets the speed at which the camera is moved to a first speed when the amount of displacement of the first operation section is smaller than a first threshold value, whereas setting the speed at which the camera is moved to a second speed when the amount of displacement of the first operation section is greater than or equal to the first threshold value.

8. The camera control apparatus according to claim 6,
wherein the speed determination section separates the amount and direction of displacement of the first operation section into the components in two axes,
when the amount of displacement projected on a first axis is greater than or equal to the amount of displacement projected on a second axis, the direction in which the camera is moved is determined to be the first axis based on the amount of displacement projected on the first axis, and the pan or tilt of the camera is determined based on the amount of displacement projected on the second axis, and
when the amount of displacement projected on the first axis is smaller than the amount of displacement projected on the second axis, the direction in which the camera is moved is determined to be the second axis based on the amount of displacement projected on the second axis, and the pan or tilt of the camera is determined based on the amount of displacement projected on the first axis.

9. A camera control method comprising the steps of
outputting a first operation signal in accordance with the amount of displacement of a first operation section, the first operation signal instructing a camera to perform pan or tilt control;
outputting a second operation signal in accordance with the amount of displacement of a second operation section, the second operation signal limiting the speed at which the camera is moved;
producing a maximum value variable that limits the speed at which the camera is moved within a predetermined range based on the second operation signal;
determining the speed at which the camera is moved in accordance with the first operation signal so that the speed is smaller than or equal to the maximum value variable; and
producing a control command for controlling the direction in which the camera is moved and the speed at which the camera is moved based on the determined speed at which the camera is moved.

10. The camera control apparatus according to claim 7,
wherein the speed determination section separates the amount and direction of displacement of the first operation section into the components in two axes,
when the amount of displacement projected on a first axis is greater than or equal to the amount of displacement projected on a second axis, the direction in which the camera is moved is determined to be the first axis based on the amount of displacement projected on the first axis, and the pan or tilt of the camera is determined based on the amount of displacement projected on the second axis, and
when the amount of displacement projected on the first axis is smaller than the amount of displacement projected on the second axis, the direction in which the camera is moved is determined to be the second axis based on the amount of displacement projected on the second axis, and the pan or tilt of the camera is determined based on the amount of displacement projected on the first axis.
